(19) United States
(12) Patent Application Publication
(10) Pub. No.: US 2024/0117656 A1
(43) Pub. Date: Apr. 11, 2024

(54) ELECTRONIC LOCK FOR ASSEMBLED CABINET

(71) Applicant: XIAMEN HEADLEADER TECHNOLOGY CO., LTD., Fujian (CN)

(72) Inventors: Tingpeng LIU, Xiang'an District (CN); Junmin LIN, Xiang'an District (CN); Jiasheng ZHANG, Xiang'an District (CN); Wang CHEN, Xiang'an District (CN)

(21) Appl. No.: 18/540,917

(22) Filed: Dec. 15, 2023

(51) Int. Cl. E05B 47/00

(52) U.S. Cl. CPC E05B 47/0012; E05B 45/06; E05B 2047/0017; E05B 2047/002; E05B 2047/0054; E05B 2047/0058; E05B 2047/0067

(57) ABSTRACT

An electronic lock for an assembled cabinet, including a lock shell, a locking and unlocking assembly mounted on the lock shell, an electronic driving device, a wireless communication device, a control circuit board, and a power supply. The control circuit board is electrically connected to the electronic driving device, the wireless communication device, and the power supply. The electronic driving device transmits motion to the locking and unlocking assembly. The electronic lock is adaptable to free combination of an assembled cabinet to provide easy installation and convenient use.

### BACKGROUND OF THE INVENTION

The present invention relates to the field of storage cabinets, and in particular, to an electronic lock for an assembled cabinet.

A storage cabinet is a cabinet for storing objects. It usually has a plurality of separated storage spaces, and it is widely used in shopping malls, supermarkets, airports, stations, gymnasiums, and the like.

Most of the existing storage cabinets have a fixed structure (namely, the respective separated storage spaces of the storage cabinet cannot be freely adjusted and rearranged), so it is very difficult to freely adjust a quantity of the storage spaces of such a storage cabinet according to user's need, meaning that there are limitations in use. In addition, if an electronic lock is mounted to a storage cabinet having a fixed structure, a complex power supplying structure needs to be arranged to supply power to the electronic lock.

A few of the existing storage cabinets are assembled cabinets. An assembled cabinet is a cabinet obtainable by freely combining different cabinet body units. User can combine different quantities of cabinet body units to form a desired assembled cabinet, and each of the cabinet body units has a single storage space. A cabinet door of each cabinet body unit of an existing assembled cabinet is generally locked and unlocked through a lock, so as to ensure independent use and safety of each cabinet body unit. Since an assembled cabinet is obtainable by freely combining different cabinet body units, the lock for each cabinet body unit of the assembled cabinet is usually a mechanical lock which does not need to be powered. However, mechanical lock is inconvenient to use since a corresponding mechanical key is required to unlock the lock, and mechanical key has poor safety of use because it is easy to be forged.

In view of the above problems, it is necessary to provide an electronic lock for an assembled cabinet, where the electronic lock can be easily installed and use.

### BRIEF SUMMARY OF THE INVENTION

The present invention aims to provide an electronic lock for an assembled cabinet, where the electronic lock can be easily installed and use.

To achieve the above objects, the present invention adopts the following technical solutions:

An electronic lock for an assembled cabinet, comprising a lock shell, a locking and unlocking assembly, an electronic driving device, a wireless communication device, a control circuit board, and a power supply; wherein the locking and unlocking assembly is mounted on the lock shell; the electronic driving device is mounted inside the lock shell; the electronic driving device is coupled to the locking and unlocking assembly to transmit motion to the locking and unlocking assembly; the wireless communication device is mounted inside the lock shell; the control circuit board and the power supply are mounted inside the lock shell; and the control circuit board is electrically connected to the electronic driving device, the wireless communication device, and the power supply; when the control circuit board receives an unlocking instruction through the wireless communication device, the control circuit board drives the locking and unlocking assembly to achieve unlocking through the electronic driving device.

The control circuit board is located in a middle of an inner cavity of the lock shell; the control circuit board divides the inner cavity of the lock shell into a power supply mounting cavity and a locking and unlocking mounting cavity which are opposite to each other; the power supply is mounted in the power supply mounting cavity; the locking and unlocking assembly and the electronic driving device are mounted in the locking and unlocking mounting cavity.

The electronic lock further comprises a tongue which is extendable out of and retractable into the lock shell; the control circuit board is provided with a sensing switch that senses a position of the tongue; when the sensing switch of the control circuit board senses that the tongue is in a locked position, the control circuit board drives the locking and unlocking assembly to achieve locking through the electronic driving device.

According to the above technical solutions, the electronic lock for the assembled cabinet is provided with its own power supply. In this way, the electronic lock does not need to be provided with an additional power supplying structure when mounted on a cabinet body unit of the assembled cabinet, so that a complex power supplying structure can be prevented from being arranged on the cabinet body unit of the assembled cabinet, and it is also easy to mount the electronic lock for the assembled cabinet on the cabinet body unit of the assembled cabinet, and the cabinet body units of the assembled cabinet can be maintained to be independent from one another. Therefore, the electronic lock of the assembled cabinet of the present invention can adapt to the characteristic of free combination of cabinet body units which are combined and assembled to form the assembled cabinet, and the assembled cabinet using such electronic lock can be formed by freely combining a number of cabinet body units according to user's requirement. In addition, the electronic lock for the assembled cabinet according to the present invention achieves unlocking in a manner that “when the control circuit board receives the unlocking instruction through the wireless communication device, the control circuit board drives the locking and unlocking assembly to achieve unlocking through the electronic driving device”. In this way, the locking and unlocking assembly can be controlled to achieve unlocking without being manually operated, so that the electronic lock is more convenient and quicker to use.

### BRIEF DESCRIPTION OF THE DRAWINGS

FIG. 1 is a structural exploded view I of the present invention.

FIG. 2 is a structural exploded view II of the present invention.

FIG. 3 is a schematic structural view I of the present invention.

FIG. 4 is a schematic structural view II of the present invention.

FIG. 5 is a partial structural view I of the present invention.

FIG. 6 is a partial structural view II of the present invention.

FIG. 7 is a partial structural view III of the present invention.

FIG. 8 is a cross-sectional view I of the present invention.

FIG. 9 is a cross-sectional view II of the present invention.

FIG. 10 is a cross-sectional view III of the present invention.

FIG. 11 is a cross-sectional view IV of the present invention.

FIG. 12 is a partial schematic circuit diagram I of a control circuit board of the present invention.

FIG. 13 is a partial schematic circuit diagram II of a control circuit board of the present invention.

FIG. 14 is a partial schematic circuit diagram III of a control circuit board of the present invention.

FIG. 15 is a schematic circuit diagram of a wireless communication device of the present invention.

FIG. 16 is a schematic circuit diagram of a wake-up switch of the present invention.

### DESCRIPTION OF REFERENCE NUMERALS

lock shell 1, inner cavity 1000, power supply mounting cavity 1001, locking and unlocking mounting cavity 1002, lock cover 101, lock box 102, bottom cover 103, protection plate 104, exposing port 11, threaded hole 12, lock post 13, exposing hole 14, slot 15, battery mounting slot 16, positive contact 161, negative contact 162, battery mounting port 17, battery cover 18, through hole 19,
locking and unlocking assembly 2, lock cylinder 21, key slot 211, lock pin 212, latch 22, lock cylinder sleeve 23, limiting groove 231, status identification member 24, unlocking magnet 25, locking magnet 26,
electronic driving device 3, driving motor 31, speed reducer 32, driving seat 33,
wireless communication device 4,
control circuit board 5, opening 50, first Hall sensing circuit 51, bipolar Hall element Q1, main control circuit 52, motor driving circuit 53, motor connecting terminal J-DJ, wireless connecting circuit 54, communication connecting terminal J-TX, storage circuit 55, power supplying circuit 56, power supply terminal J-BAT, control power supplying circuit 561, controllable booster circuit 562, electronic switch circuit 5621, DC-DC booster circuit 5622, second Hall sensing circuit 57, all-polarity Hall element Q2, buzzer alarm circuit 58, wake-up switch connecting circuit 59, wake-up switch connecting terminal J-SW, sensing switch K1,
power supply 6, battery 61,
gear transmission mechanism 7, driving wheel 71, driven wheel 72,
wake-up switch 8, operation region 81,
handle 9,
tongue 10, and reset spring 100.

### DETAILED DESCRIPTION OF THE INVENTION

To further explain the technical solutions of the present invention, a detailed description of the present invention is provided below through specific embodiments.

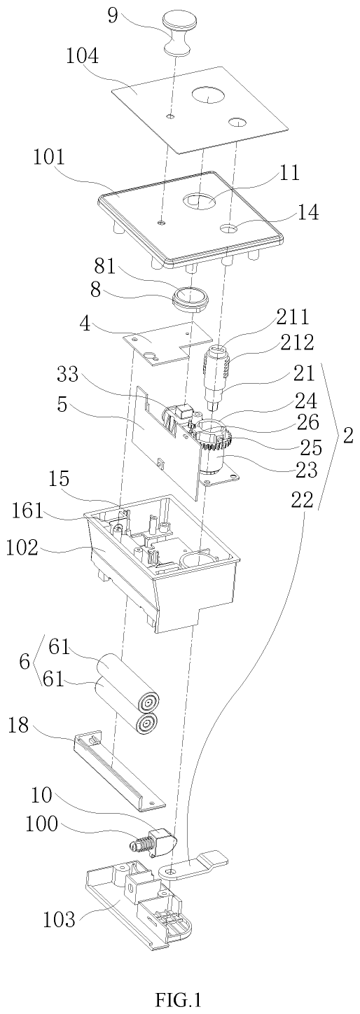

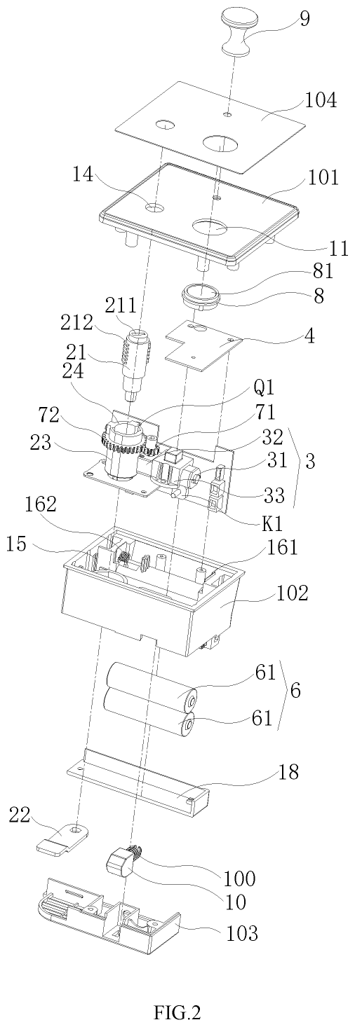

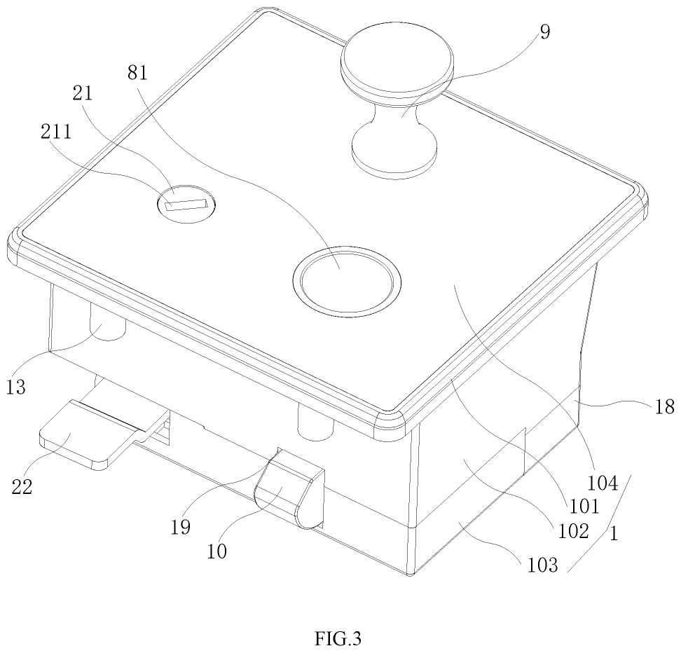

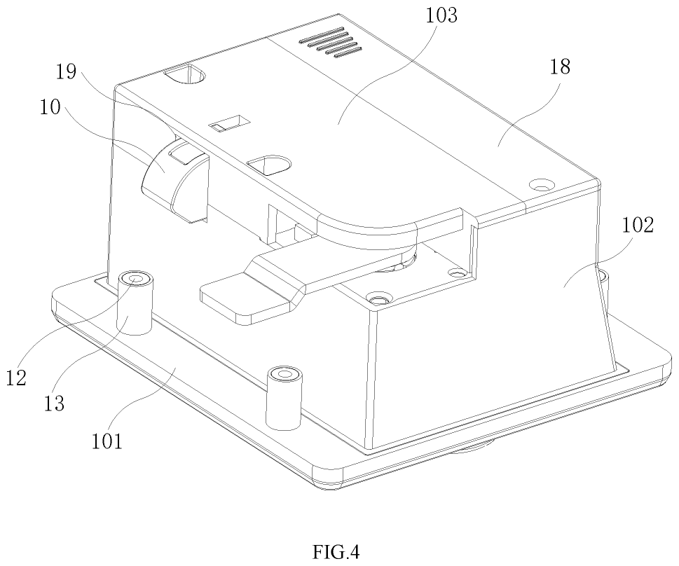

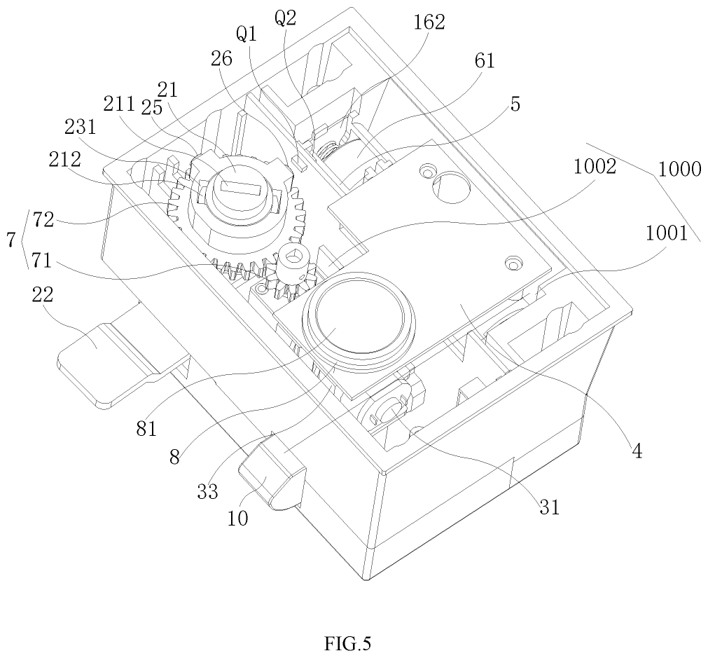

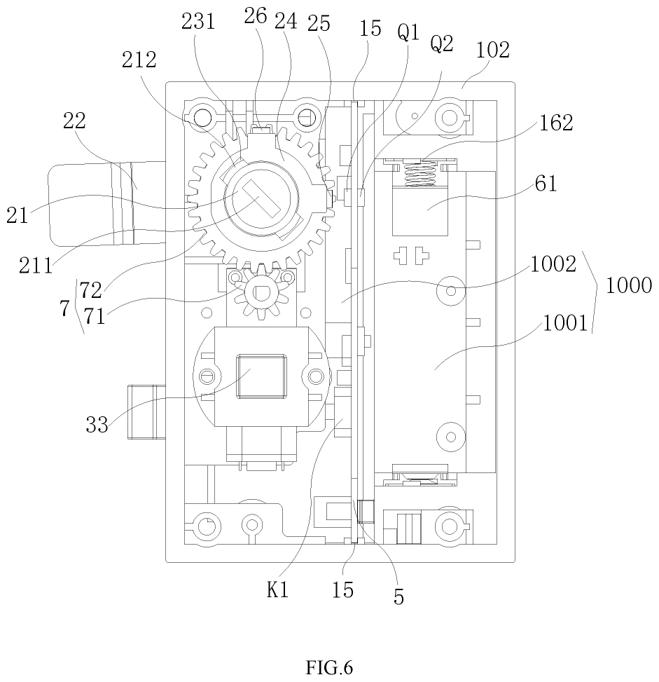

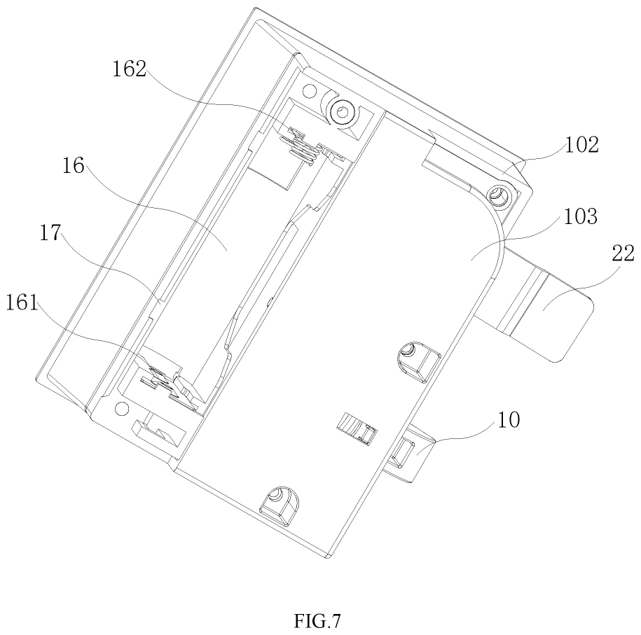

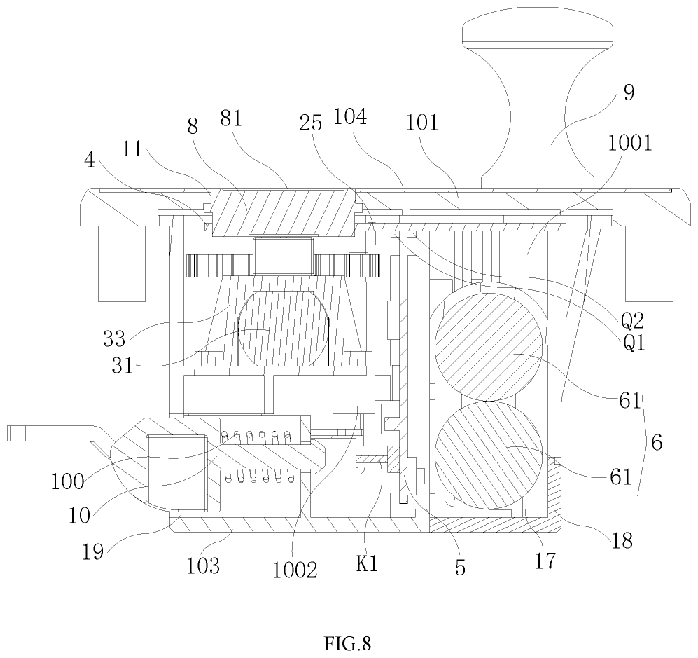

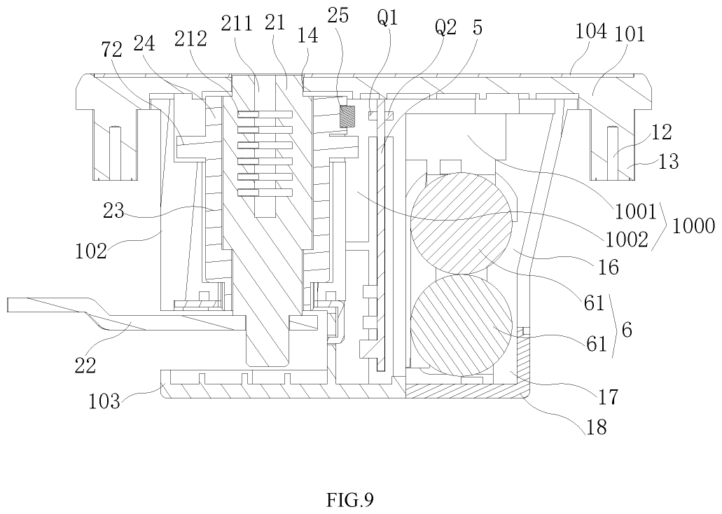

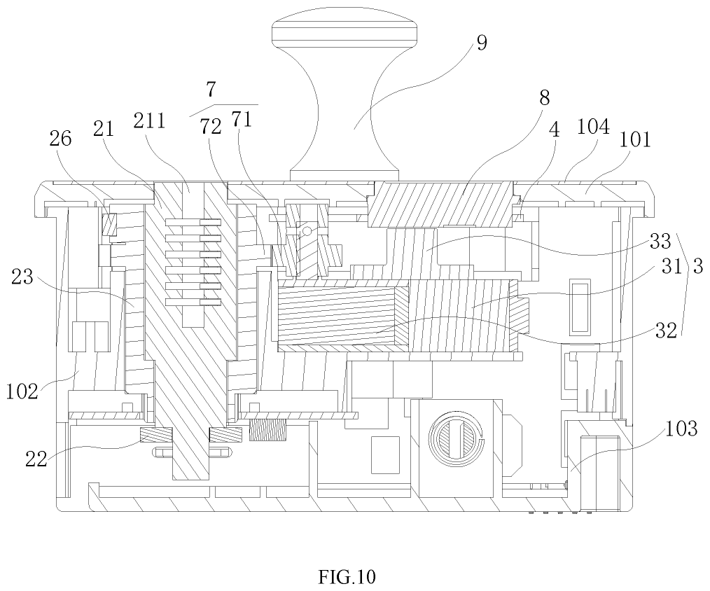

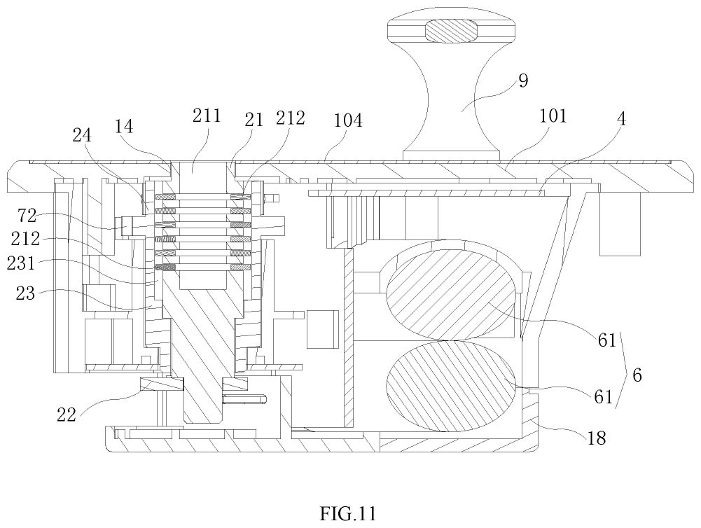

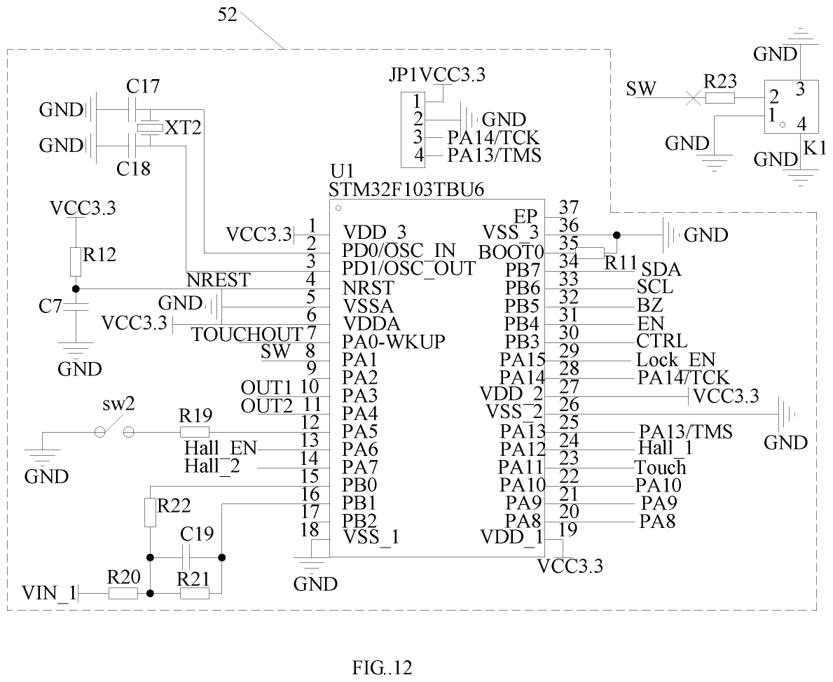

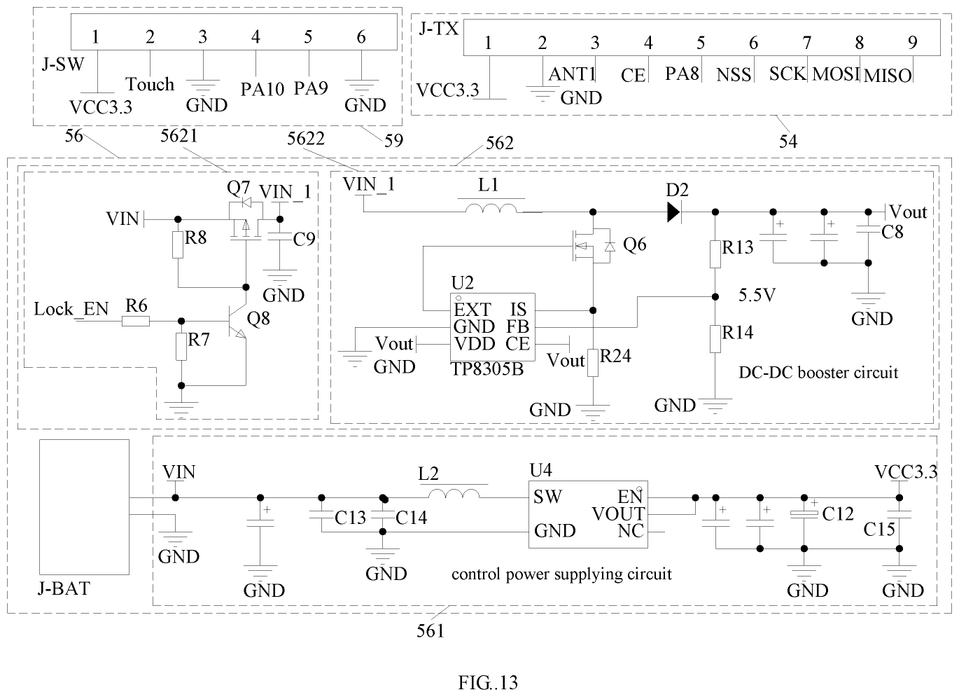

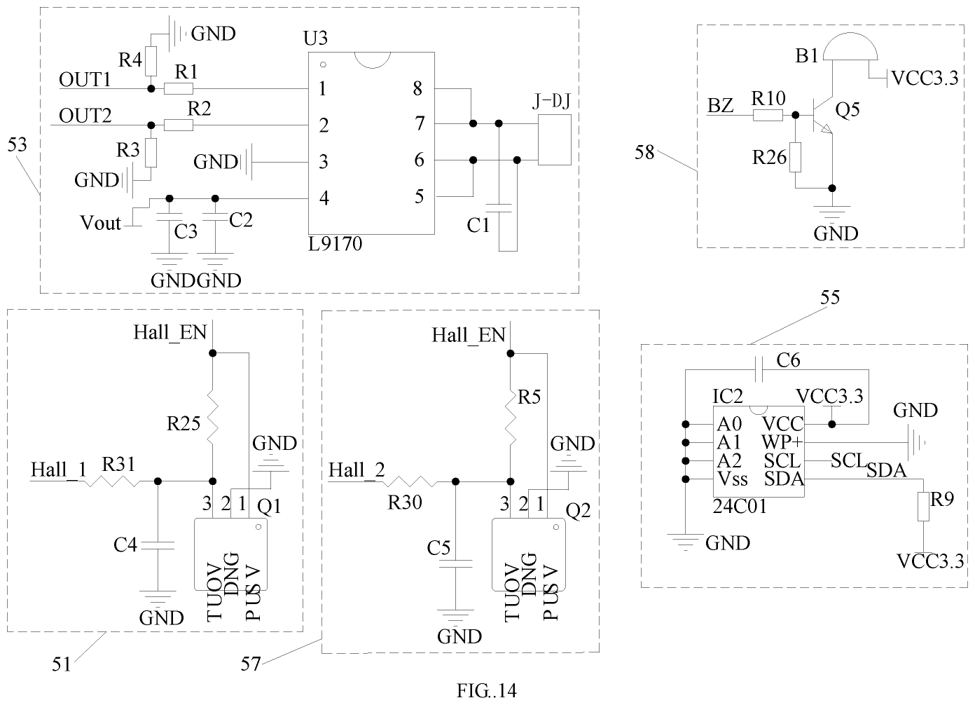

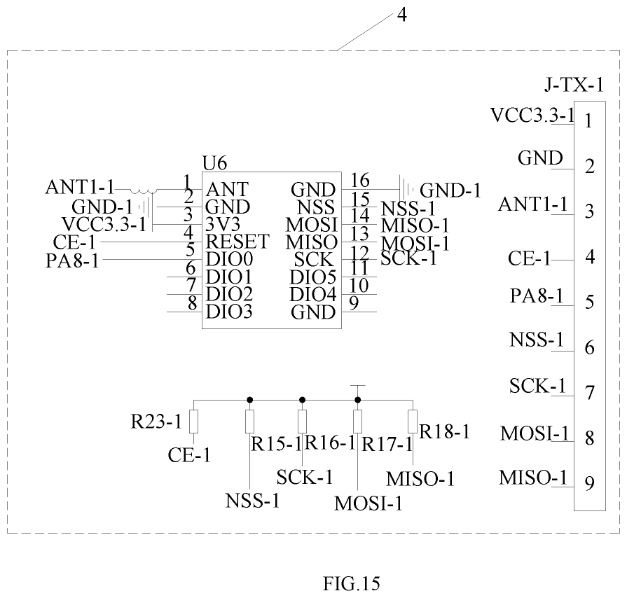

As shown in FIGS. 1 to 16, the present invention discloses an electronic lock for an assembled cabinet, comprising a lock shell 1, a locking and unlocking assembly 2, an electronic driving device 3, a wireless communication device 4, a control circuit board 5, and a power supply 6, wherein the locking and unlocking assembly 2 is mounted on the lock shell 1; the electronic driving device 3 is mounted inside the lock shell 1; the electronic driving device 3 is coupled to the locking and unlocking assembly 2 to transmit motion to the locking and unlocking assembly 2; the wireless communication device 4 is mounted inside the lock shell 1; the wireless communication device 4 is configured to communicate with a cloud server; the control circuit board 5 and the power supply 6 are mounted inside the lock shell 1; and the control circuit board 5 is electrically connected to the electronic driving device 3, the wireless communication device 4, and the power supply 6.

During use of the electronic lock for the assembled cabinet of the present invention, the control circuit board 5 communicates with the cloud server through the wireless communication device 4; a user communicates with the cloud server through an intelligent terminal (such as a smart phone, a tablet computer, or a smart watch). The user sends an unlocking instruction to the cloud server through the intelligent terminal, and the cloud server sends the unlocking instruction to the corresponding electronic lock of the assembled cabinet. According to the present invention, when the control circuit board 5 receives the unlocking instruction through the wireless communication device 4, the control circuit board 5 drives the locking and unlocking assembly 2 to achieve unlocking through the electronic driving device 3. In addition, the user can also send a locking instruction to the cloud server through the intelligent terminal, and the cloud server sends the locking instruction to the corresponding electronic lock of the assembled cabinet. When the control circuit board 5 receives the locking instruction through the wireless communication device 4, the control circuit board 5 drives the locking and unlocking assembly 2 to achieve locking through the electronic driving device 3. In the present invention, the locking and unlocking assembly 2 can be controlled to achieve locking without being manually operated, so that the electronic lock is more convenient and quicker to use.

In the present invention, the electronic lock for the assembled cabinet is provided with the power supply 6. In this way, the electronic lock of the assembled cabinet does not need to be provided with an additional power supplying structure when mounted on a cabinet body unit of the assembled cabinet, so that a complex power supplying structure can be prevented from being arranged on the cabinet body unit of the assembled cabinet, and it is also easy to mount the electronic lock for the assembled cabinet on the cabinet body unit of the assembled cabinet, and the cabinet body units of the assembled cabinet can be maintained to be independent from one another. Therefore, the electronic lock of the assembled cabinet of the present invention can adapt to the characteristic of free combination of cabinet body units which are combined and assembled to form the assembled cabinet, and the assembled cabinet using such electronic lock can be formed by freely combining a number of cabinet body units according to user's requirement. In addition, the electronic lock for the assembled cabinet according to the present invention achieves unlocking as mentioned above, namely that “when the control circuit board 5 receives the unlocking instruction through the wireless communication device 4, the control circuit board 5 drives the locking and unlocking assembly 2 to achieve unlocking through the electronic driving device”. In this way, the locking and unlocking assembly 2 can be controlled to achieve unlocking without being manually operated, so that the electronic lock is more convenient and quicker to use.

In an embodiment of the present invention, the lock shell 1 comprises a lock cover 101, a lock box 102, and a bottom cover 103 which are connected, so that it is convenient to mount the locking and unlocking assembly 2, the electronic driving device 3, the wireless communication device 4, the control circuit board 5, and the power supply 6; the lock shell 1 is provided with a plurality of threaded holes 12 to fix the electronic lock on a cabinet door of a cabinet body unit of the assembled cabinet; and the threaded holes 12 may be specifically arranged on lock posts 13 of the lock cover 101. An exposing port 11 of the lock shell 1 is formed on the lock cover 101; a metal protection plate 104 can be fitted on the lock cover 101; and the protection plate 104 can be specifically made of a stainless steel material.

In an embodiment of the present invention, the locking and unlocking assembly 2 comprises a lock cylinder 21 and a latch 22; the lock cylinder 21 is rotatably mounted in the lock shell 1; the latch 22 is connected to the lock cylinder 21; one end of the latch 22 extends out of the lock shell 1; the electronic driving device 3 is coupled to the lock cylinder 21 of the locking and unlocking assembly 2 to transmit motion to the lock cylinder 21; the electronic driving device 3 drives the locking and unlocking assembly 2 to achieve unlocking and locking by driving the lock cylinder 21 and the latch 22 to rotate.

In an embodiment of the present invention, the locking and unlocking assembly 2 further comprises a lock cylinder sleeve 23; the lock cylinder sleeve 23 is rotatably mounted in the lock shell 1 and sleeves the lock cylinder 21; at least one limiting groove 231 is arranged on an inner surface of the lock cylinder sleeve 23; the lock cylinder 21 is provided with a key slot 211 for achieving unlocking by a mechanical key; at least one lock pin 212 of the lock cylinder 21 is removably engaged with said at least one limiting groove 231; the electronic driving device 3 transmits motion to the lock cylinder 21 through the lock cylinder sleeve 23; the lock shell 1 is provided with an exposing hole 14 facing directly to the lock cylinder 21; the exposing hole 14 is formed on the lock cover 101; one end of the lock cylinder 21 is inserted into the exposing hole 14. When the electronic lock for the assembled cabinet of the present invention is in a normal use state, said at least one lock pin 212 of the lock cylinder 2 engage with said at least one limiting groove 231 of the lock cylinder sleeve 23 so that the lock cylinder sleeve 23 and the lock cylinder 21 are rotatable synchronously; therefore, the electronic driving device 3 can drive the lock cylinder 21 to rotate to achieve locking and unlocking by driving the lock cylinder sleeve 23 to rotate. When a correct mechanical key is inserted into the key slot 211 of the lock cylinder 21, said at least one lock pin 212 of the lock cylinder 21 is withdrawn from said at least one limiting groove 231 of the lock cylinder sleeve 23, so that the lock cylinder sleeve 23 and the lock cylinder 21 are no longer capable of rotating synchronously. In this way, the lock cylinder 21 is driven to rotate by rotating the mechanical key to achieve unlocking and locking.

In an embodiment of the present invention, the locking and unlocking assembly 2 further comprises a status identification member 24 in correspondence with rotation of the lock cylinder 21; the status identification member 24 is mounted with an unlocking magnet 25 and a locking magnet 26 which have different magnetic properties; the status identification member 24 may be fixedly connected to the lock cylinder sleeve 23, or integrally molded with the lock cylinder sleeve 23; the unlocking magnet 25 is preset to correspond to an unlocked state of the lock cylinder 21 and the latch 22; the locking magnet 26 is preset to correspond to a locked state of the lock cylinder 21 and the latch 22; the control circuit board 5 is provided with a first Hall sensing circuit 51 configured to sense the unlocking magnet 25 and the locking magnet 26, so that a status of the lock cylinder 21 and the latch 22 can be sensed and determined through sensing of the unlocking magnet 25 and the locking magnet 26 by the first Hall sensing circuit 51, thereby facilitating the control circuit board 5 to control and confirm locking and unlocking operations, thus improving reliability and safety of the present invention. Specifically, the first Hall sensing circuit 51 comprises a bipolar Hall element Q1; when the first Hall sensing circuit 51 senses the unlocking magnet 25, the first Hall sensing circuit 51 outputs a first sensing signal indicating the unlocked state; when the first Hall sensing circuit 51 senses the locking magnet 26, the first Hall sensing circuit 51 outputs a second sensing signal indicating the locked state; and the first sensing signal and the second sensing signal have different levels. In addition, the control circuit board 5 is further provided with a second Hall sensing circuit 57 configured to sense the unlocking magnet 25 and the locking magnet 26; the second Hall sensing circuit 57 has an all-polarity Hall element Q2; when the electronic driving device 3 drives the lock cylinder 21 to rotate to achieve unlocking and locking, an output signal of the second Hall sensing circuit 57 should have two level changes if the lock cylinder 21 functions normally; if the lock cylinder 21 does not function normally, the output signal of the second Hall sensing circuit 57 has only one level change or does not have any level change. Therefore, the present invention can determine, through the second Hall sensing circuit 57, whether the lock cylinder 21 functions normally (i.e. rotate as expected according to the locking and unlocking instructions) when the electronic driving device 3 drives the lock cylinder 21 to rotate to achieve unlocking and the locking.

In an embodiment of the present invention, the electronic driving device 3 transmit motion to the lock cylinder sleeve 23 through a gear transmission mechanism 7; the gear transmission mechanism 7 comprises a driving wheel 71 and a driven wheel 72 that are engaged with each other; the driving wheel 71 is connected to the electronic driving device 3; the driven wheel 72 is coaxially and fixedly connected to the lock cylinder sleeve 23; the lock cylinder sleeve 23 and the driven wheel 72 may be integrally molded. The electronic driving device 3 comprises a driving motor 31, a speed reducer 32, and a driving seat 33; the driving motor 31 and the speed reducer 32 are mounted on the driving seat 33; the driving seat 33 is fixed with the lock shell 1; the driving seat 33 may be specifically fixed with the lock box 102 of the lock shell 1; the driving motor 31 is electrically connected to the control circuit board 5; an output shaft of the driving motor 31 is connected to an input end of the speed reducer 32; an output end of the speed reducer 32 is connected to the driving wheel 71 to achieve motion transmission to the lock cylinder sleeve 23.

In an embodiment of the present invention, the wireless communication device 4 may specifically use a LoRa communication device, or may be a WiFi® communication device or a Bluetooth® communication device. The wireless communication device 4 may be fixed with the lock box 102 of the lock shell 1 by screws.

In an embodiment of the present invention, the control circuit board 5 is located in a middle of an inner cavity 1000 of the lock shell 1; the control circuit board 5 divides the inner cavity 1000 of the lock shell 1 into a power supply mounting cavity 1001 and a locking and unlocking mounting cavity 1002 which are opposite to each other; the power supply 6 is mounted in the power supply mounting cavity 1001; and the locking and unlocking assembly 2, the electronic driving device 3, and the gear transmission mechanism 7 are all mounted in the locking and unlocking mounting cavity 1002. In this way, the electronic lock for the assembled cabinet of the present invention is compact in structure to reduce the size of the electronic lock. The inner cavity 1000 of the lock shell 1 is provided with two opposite slots 15, and two ends of the control circuit board 5 are inserted into the two opposite slots 15 respectively, so as to mount the control circuit board 5 into the inner cavity 1000 of the lock shell 1; the wireless communication device 4 is positioned to intersect with the control circuit board 5; the control circuit board 5 is provided with an opening 50 for intersection by the wireless communication device 4; a battery mounting slot 16 is formed in the power supply mounting cavity 1001; the power supply 6 comprises at least one battery 61 which is detachably mounted in the battery mounting slot 16; the battery mounting slot 16 is provided with a positive contact 161 and a negative contact 162 for each battery 61 so that the positive contact 161 and the negative contact 162 are in contact with the corresponding battery 61; the positive contact 161 and the negative contact 162 are connected to the control circuit board 5; the lock shell 1 is provided with a battery mounting port 17 in communication with the battery mounting slot 16; the battery mounting port 17 is formed on the lock box 102; a battery cover 18 detachably mounted to the lock shell 1 is provided to cover the battery mounting port 17 to prevent the battery 61 from falling out; the battery cover 18 can be fixed connected to the lock shell 1 by screws.

In an embodiment of the present invention, the control circuit board 5 comprises a main control circuit 52, a motor driving circuit 53, a wireless connecting circuit 54, a storage circuit 55, and a power supplying circuit 56, wherein the main control circuit 52 is electrically connected to the first Hall sensing circuit 51 and the second Hall sensing circuit 57; the motor driving circuit 53 is electrically connected to the electronic driving device 3; the motor driving circuit 53 is provided with a motor connecting terminal J-DJ connected to the driving motor 31 of the electronic driving device 3; a first control end and a second control end of the motor driving circuit 53 are electrically connected to the main control circuit 52; ground ends of the motor driving circuit 53 are grounded; the wireless connecting circuit 54 is electrically connected to the wireless communication device 4; the wireless connecting circuit 54 is provided with a communication connecting terminal J-TX connected to the wireless communication device 4; the wireless connecting circuit 54 and the storage circuit 55 are electrically connected to the main control circuit 52; the power supplying circuit 56 comprises a power supply terminal J-BAT, a control power supplying circuit 561, and a controllable booster circuit 562; a positive electrode and a negative electrode of the power supply terminal J-BAT are electrically connected to the power supply 6; the positive electrode and the negative electrode of the power supply terminal J-BAT are connected to the positive contact 161 and the negative contact 162 respectively; an input end of the control power supplying circuit 561 is electrically connected to the positive electrode of the power supply terminal J-BAT, and an output end of the control power supplying circuit 561 is electrically connected to a power supply end of the main control circuit 52; the controllable booster circuit 562 comprises an electronic switch circuit 5621 and a DC-DC booster circuit 5622; an input end of the electronic switch circuit 5621 is electrically connected to the positive electrode of the power supply terminal J-BAT; a control end of the electronic switch circuit 5621 is electrically connected to the main control circuit 52; an output end of the electronic switch circuit 5621 is electrically connected to an input end of the DC-DC booster circuit 5622; an output end of the DC-DC booster circuit 5622 is electrically connected to the power supply end of the motor driving circuit 53; the negative electrode of the power supply terminal J-BAT, ground ends of the control power supplying circuit 561, ground ends of the electronic switch circuit 5621, ground ends of the DC-DC booster circuit 5622, and ground ends of the main control circuit 52 are all grounded to earth. The main control circuit 52 of the present invention controls the electronic driving device 3 by controlling the motor driving circuit 53, wherein in the present invention, when the lock cylinder 21 and the latch 22 are controlled to be unlocked or locked, the main control circuit 52 controls the electronic switch circuit 5621 to be activated, so that the power supply 6 supplies power to the DC-DC booster circuit 5622 to enable the DC-DC booster circuit 5622 to operate; then the DC-DC booster circuit 5622 supplies power to the motor driving circuit 53, so that the main control circuit 52 can control the motor driving circuit 53; when the motor driving circuit 53 is not required to be controlled (that is, when the electronic lock for the assembled cabinet of the present invention is in a standby state), the main control circuit 52 controls the electronic switch circuit 5621 to be deactivated, so that the power supply 6 does not supply power to the DC-DC booster circuit 5622, and the DC-DC booster circuit 5622 is powered off and stops operating. In this way, the DC-DC booster circuit 5622 does not consume power, and the standby power consumption of the electronic lock can be effectively reduced, thereby effectively prolonging the endurance of the electronic lock.

In an embodiment of the present invention, the control circuit board 5 is further provided with a buzzer alarm circuit 58 electrically connected to the main control circuit 52. When the main control circuit 52 of the control circuit board 5 has detected, through the first Hall sensing circuit 51, that the lock cylinder 21 and the latch 22 are not unlocked or locked properly, the main control circuit 52 controls the buzzer alarm circuit 58 to send an alarm to remind the user. In addition, when the main control circuit 52 of the control circuit board 5 has detected, through the second Hall sensing circuit 57, that the lock cylinder 21 does not rotate as usual, the main control circuit 52 controls the buzzer alarm circuit 58 to send an alarm to remind the user.

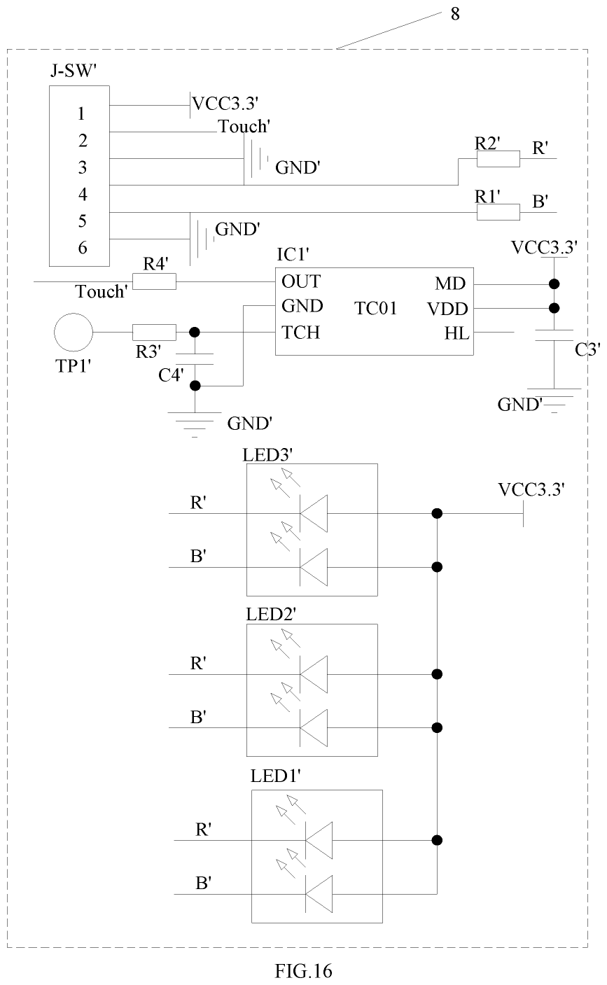

In an embodiment of the present invention, the electronic lock for the assembled cabinet further comprises a wake-up switch 8; the wake-up switch 8 is mounted in the lock shell 1 and connected to the control circuit board 5; the lock shell 1 is provided with the exposing port 11 corresponding to the wake-up switch 8; an operation region 81 of the wake-up switch 8 is exposed from the exposing port 11 for the user to operate; and the wake-up switch 8 is configured to wake up the wireless communication device 4. The electronic lock is in a standby state when not in use, so as to reduce the power consumption of the electronic lock and prolong the endurance of the electronic lock; when the user needs to unlock or lock the electronic lock, the user operates the wake-up switch 8 so that the wake-up switch 8 sends a wake-up instruction to the control circuit board 5, and the control circuit board 5 wakes up the wireless communication device 4; then, the user sends the unlocking instruction or the locking instruction to the cloud server through the intelligent terminal; and the cloud server sends the unlocking instruction or the locking instruction to the waken up wireless communication device 4 of the electronic lock. The wake-up switch 8 can be positioned opposite to the electronic driving device 3, and the electronic driving device 3 is connected to the wake-up switch 8, so that the wake-up switch 8 is mounted in the lock shell 1 through the electronic driving device 3. Specifically, the wake-up switch 8 may be sandwiched between the lock cover 101 of the lock shell 1 and the driving seat 33 of the electronic driving device 3, and the wake-up switch 8 is connected to the driving seat 33. The wake-up switch 8 is electrically connected to the main control circuit 52 of the control circuit board 5 to communicate with the main control circuit 52; the control circuit board 5 may be provided with a wake-up switch connecting circuit 59 electrically connected to the main control circuit 52; and the wake-up switch connecting circuit 59 is provided with a wake-up switch connecting terminal J-SW connected to the wake-up switch 8. As shown in FIG. 16, the wake-up switch 8 may specifically be a touch switch, and a touch region of the touch switch is the operation region of the wake-up switch 8.

In an embodiment of the present invention, the electronic lock for the assembled cabinet of the present invention further comprises a handle 9 connected to the lock shell 1 and located on an outer side of the lock shell 1; the handle 9 may be connected to the lock cover 101 of the lock shell 1. The handle 9 can facilitate the user to open the cabinet door of a corresponding cabinet body unit of the assembled cabinet.

In an embodiment of the present invention, the electronic lock for the assembled cabinet of the present invention further comprises a tongue 10 which is extendable out of and retractable into the lock shell 1. When the cabinet door of the cabinet body unit of the assembled cabinet is closed, the tongue 10 may abut against a cabinet body of the cabinet body unit of the assembled cabinet to keep the cabinet door closed, thus facilitating the user to use. Specifically, the tongue 10 is slidably connected to the lock shell 1; the lock shell 1 is provided with a through hole 19 for the tongue 10 to extend and retract; a reset spring 100 for resetting the tongue 10 is positioned between the lock shell 1 and the tongue 10; the tongue 10 is sleeved with the reset spring 100; two ends of the reset spring 100 abut against the lock shell 1 and the tongue 10 respectively. In addition, the control circuit board 5 is provided with a sensing switch K1 configured to sense a position of the tongue 10; and the sensing switch K1 is electrically connected to the main control circuit 52. When the sensing switch K1 of the control circuit board 5 senses that the tongue 10 is in a locked position (namely, the tongue 10 retracts as it abuts against the cabinet body), the control circuit board 5 drives the locking and unlocking assembly 2 to achieve locking through the electronic driving device 3. In this way, in the present invention, the locking and unlocking assembly 2 can be controlled to achieve locking without being manually operated, so that the electronic lock is more convenient and quicker to use. The sensing switch K1 is a micro switch; the tongue 10 removably presses the sensing switch K1 to cause the sensing switch K1 to sense the position of the tongue 10; the tongue 10 does not press the sensing switch K1 when the tongue 10 is in an unlocked position; and the tongue 10 presses the sensing switch K1 when the tongue 10 is in the locked position.

The above embodiments and illustrations are not intended to limit the form and style of the product of the present invention. Any appropriate variations or modifications made by those of ordinary skills in the art within the scope of the present invention shall be considered as falling within the scope of the patent.

What is claimed is:

1. An electronic lock for an assembled cabinet, comprising a lock shell, a locking and unlocking assembly, an electronic driving device, a wireless communication device, a control circuit board, and a power supply;
the locking and unlocking assembly is mounted on the lock shell;
the electronic driving device is mounted inside the lock shell; the electronic driving device is coupled to the locking and unlocking assembly to transmit motion to the locking and unlocking assembly;
the wireless communication device is mounted inside the lock shell;
the control circuit board and the power supply are mounted inside the lock shell; and the control circuit board is electrically connected to the electronic driving device, the wireless communication device, and the power supply; when the control circuit board receives an unlocking instruction through the wireless communication device, the control circuit board drives the locking and unlocking assembly to achieve unlocking through the electronic driving device.

2. The electronic lock of claim 1, wherein the locking and unlocking assembly comprises a lock cylinder and a latch; the lock cylinder is rotatably mounted in the lock shell; the latch is connected to the lock cylinder; one end of the latch extends out of the lock shell; the electronic driving device is coupled to the lock cylinder to transmit motion to the lock cylinder.

3. The electronic lock of claim 2, wherein the locking and unlocking assembly further comprises a lock cylinder sleeve; the lock cylinder sleeve is rotatably mounted in the lock shell and sleeves the lock cylinder; at least one limiting groove is arranged on an inner surface of the lock cylinder sleeve; the lock cylinder is provided with a key slot; at least one lock pin of the lock cylinder is removably engaged with said at least one limiting groove;
the electronic driving device transmits motion to the lock cylinder through the lock cylinder sleeve;
the lock shell is provided with an exposing hole facing directly to the lock cylinder; one end of the lock cylinder is inserted into the exposing hole.

4. The electronic lock of claim 3, wherein the electronic driving device transmits motion to the lock cylinder sleeve through a gear transmission mechanism.

5. The electronic lock of claim 2, wherein the locking and unlocking assembly further comprises a status identification member in correspondence with rotation of the lock cylinder; the status identification member is mounted with an unlocking magnet and a locking magnet which have different magnetic properties; the control circuit board is provided with a first Hall sensing circuit that senses the unlocking magnet and the locking magnet.

6. The electronic lock of claim 5, wherein the control circuit board is further provided with a second Hall sensing circuit that senses the unlocking magnet and the locking magnet; the second Hall sensing circuit has an all-polarity Hall element; the first Hall sensing circuit has a bipolar Hall element.

7. The electronic lock of claim 1, wherein the control circuit board is located in a middle of an inner cavity of the lock shell; the control circuit board divides the inner cavity of the lock shell into a power supply mounting cavity and a locking and unlocking mounting cavity which are opposite to each other; the power supply is mounted in the power supply mounting cavity; the locking and unlocking assembly and the electronic driving device are mounted in the locking and unlocking mounting cavity.

8. The electronic lock of claim 7, wherein a battery mounting slot is formed in the power supply mounting cavity; the power supply comprises at least one battery which is detachably mounted in the battery mounting slot;
the lock shell is provided with a battery mounting port in communication with the battery mounting slot; a battery cover detachably mounted to the lock shell is provided to cover the battery mounting port.

9. The electronic lock of claim 7, wherein the inner cavity of the lock shell is provided with two opposite slots, and two ends of the control circuit board are inserted into the two opposite slots respectively.

10. The electronic lock of claim 1, further comprising a handle connected to the lock shell and located on an outer side of the lock shell.

11. The electronic lock of claim 1, further comprising a tongue which is extendable out of and retractable into the lock shell; the control circuit board is provided with a sensing switch that senses a position of the tongue; when the sensing switch of the control circuit board senses that the tongue is in a locked position, the control circuit board drives the locking and unlocking assembly to achieve locking through the electronic driving device.

12. The electronic lock of claim 1, further comprising a wake-up switch; the wake-up switch is mounted in the lock shell and connected to the control circuit board; the lock shell is provided with an exposing port corresponding to the wake-up switch; an operation region of the wake-up switch is exposed from the exposing port.

13. The electronic lock of claim 12, wherein the wake-up switch is positioned opposite to the electronic driving device, and the electronic driving device is connected to the wake-up switch.

14. The electronic lock of claim 1, wherein the control circuit board comprises a main control circuit, a motor driving circuit, a wireless connecting circuit, a storage circuit, and a power supplying circuit;
the motor driving circuit is electrically connected to the electronic driving device; a first control end and a second control end of the motor driving circuit are electrically connected to the main control circuit; ground ends of the motor driving circuit are grounded;
the wireless connecting circuit is electrically connected to the wireless communication device; the wireless connecting circuit and the storage circuit are electrically connected to the main control circuit;
the power supplying circuit comprises a power supply terminal, a control power supplying circuit, and a controllable booster circuit; a positive electrode and a negative electrode of the power supply terminal are electrically connected to the power supply; an input end of the control power supplying circuit is electrically connected to the positive electrode of the power supply terminal, and an output end of the control power supplying circuit is electrically connected to a power supply end of the main control circuit; the controllable booster circuit comprises an electronic switch circuit and a DC-DC booster circuit; an input end of the electronic switch circuit is electrically connected to the positive electrode of the power supply terminal; a control end of the electronic switch circuit is electrically connected to the main control circuit; an output end of the electronic switch circuit is electrically connected to an input end of the DC-DC booster circuit; an output end of the DC-DC booster circuit is electrically connected to a power supply end of the motor driving circuit; the negative electrode of the power supply terminal, ground ends of the control power supplying circuit, ground ends of the electronic switch circuit, ground ends of the DC-DC booster circuit, and ground ends of the main control circuit are all grounded to earth.

15. The electronic lock of claim 14, wherein the control circuit board is further provided with a buzzer alarm circuit electrically connected to the main control circuit.
